(19) United States
(12) Patent Application Publication
(10) Pub. No.: US 2008/0095911 A1
(43) Pub. Date: Apr. 24, 2008

(54) Satiety Enhancing Food Product And A Method For Manufacturing Such

(76) Inventors: Sarah Adams, Bedford (GB); Michael Francis Butler, Sharnbrook (GB); Allan Hugh Clark, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/792,651

(22) PCT Filed: Nov. 11, 2005
(86) PCT No.: PCT/EP05/12227

§ 371 Date: Jun. 8, 2007

(30) Foreign Application Priority Data
Dec. 8, 2004 (EP) 04257612.4

(51) Int. Cl. A23L 1/00; A23L 1/29; A23L 1/30; A23L 1/307

(52) U.S. Cl. 426/573

(57) ABSTRACT

A food product is provided comprising at least 50 grams of a pH responsive hydrogel comprising a cross-linked globular protein having an unfolding transition pH in the range pH 2 to 6. Also provided are a process for manufacturing the food product and use of a pH responsive hydrogel to provide an enhanced feeling of satiety to a person consuming the hydrogel and/or to aid adherence to a weight loss or weight control plan.

### FIELD OF THE INVENTION

The present invention relates to food products having an enhanced satiety effect and methods for their manufacture and use.

### BACKGROUND OF THE INVENTION

The incidence of obesity and the number of people considered overweight in countries where a so-called Western diet is adopted has drastically increased over the last decade. Since obesity and being overweight are generally known to be associated with a variety of diseases such as heart disease, type 2 diabetes, hypertension and arthereosclerosis, this increase is a major health concern for the medical world and for individuals alike. Furthermore, being overweight is considered by the majority of the Western population as unattractive.

This has led to an increasing interest by consumers in their health and has created a demand for products that help to reduce or control daily caloric intake and/or control body weight and/or bodily appearance.

Several solutions have been proposed to help individuals to control their weight. Among these solutions is the use of drugs e.g. to suppress the activity of enzymes in the digestive system. However the use of drugs is often not preferred unless strictly required for medical purposes.

Another proposed solution is to prescribe the individuals a specific diet, for example, a diet with a restricted caloric intake per day. A problem with these diets is that often they do not provide a healthy nutritional balance and/or they are difficult to accommodate in modern lifestyles.

Meal replacer products have also been proposed as part of a healthy diet in order to control or reduce body weight.

These meal replacer products are generally products that are intended to be consumed as a single-serving food product, such as a bar, drink etc to replace one or two meals per day. The meal replacer products are designed such that on the one hand they provide a restricted caloric intake, but on the other hand they provide a healthy balance of nutritional ingredients and are convenient to incorporate into an individual's daily diet.

However, a general problem with products intended to be used in a weight loss or weight maintenance plan, e.g. meal replacer products or low-calorie snacks, is that feelings of hunger may occur sooner than desired after consumption and/or the feeling of satiety obtained may not be as great as desired. Both of these considerations may render it difficult for the individual to adhere to the plan or it may make it and/or the products used therein less appealing to consumers.

Recognising the demand for effective and convenient satiety-inducing food products, research has been carried out to try to address the problems associated with the above approaches to controlling or reducing body weight.

One approach to addressing the aforementioned problems has been to investigate the use of satiety agents in food products to increase the satiety effect obtained from consuming a food product comprising the satiety agents.

Satiety agents have been described which produce a swelled polymer gel that is retained in the stomach and/or increases the viscosity of the stomach contents to thereby delay gastric emptying.

WO 03/065825 A1 discloses a food or food additive that causes a longer-lasting feeling of satiety, useful as an appetite depressant and comprising a cross-linked protein. Cross-linked proteins are said to be subject to a prolonged residence in the stomach when they are present there in the form of a gel.

However, the satiety effect obtained by these compositions is often not optimal and the presence of pre-swelled gelatinous material in the foodstuff prior to ingestion often results in undesirably high viscosity and/or unpalatable texture of the food.

One approach, described in US 2004/0192582, to avoid swelling before the satiety agent reaches the gastric environment is to include an acid-sensitive gelatin coating over a dehydrated hydrophilic polymer. When ingested, the acid-sensitive coating is quickly dissolved by gastric secretions and the hydrophilic polymer is exposed to the aqueous environment of the gastric milieu. The polymer absorbs water and expands to the point that will not allow the polymer to pass beyond the pyloric valve, and the expanded polymer is therefore trapped in the stomach.

Unfortunately, such dehydrated compositions which are primarily designed for administration as a capsule, tablet or pill are not amenable for formulating in most foods as the aqueous environment of a food would necessarily cause some swelling of the composition prior to ingestion and therefore reduce its efficacy. Furthermore, such dehydrated compositions are likely to be orally detectable when included in an edible matrix and therefore would impart an undesirable texture and palatability if employed as a foodstuff.

There is thus a need for a satiety agent suitable for use in foodstuffs having an enhanced satiety effect whilst remaining palatable. In particular there is a need to provide foods with a satiety agent which remains inert during storage and ingestion but shows enhanced swelling in the gastric environment.

We have found that it is possible to achieve such a goal by using a pH responsive hydrogel comprising a cross-linked globular protein which has an unfolding transition pH in the range of from 2 to 6.

### TESTS AND DEFINITIONS

Swelling Factor

The swelling factor for a hydrogel equilibrated with a chosen aqueous solution for 24 hours at room temperature (20° C.) is calculated using equation 1:
Swelling factor(%)=100(mₑ−m₀)/m₀, (1)
where m₀ is the mass of the gel prior to swelling and n is the mass of the equilibrated hydrogel.

The swelling factor is determined as follows.

A small (typically ˜0.02 g) sample of hydrogel is taken and accurately weighed, the resulting mass being recorded as mₒ. The sample is then immediately placed in a large excess (typically ˜5 g) of the chosen aqueous solution. The aqueous solution and hydrogel sample are then stored for 24 hours in a sealed container at a constant room temperature (20° C.). The hydrogel sample is then removed from the solution and placed on a paper towel for a few seconds to remove excess liquid from the surface of the sample. The sample is then immediately weighed, the resulting mass being recorded as mₑ. The swelling factor is then calculated using equation 1. The value of the swelling factor quoted for a hydrogel is the mean of at least three samples and the error quoted is the associated 95% confidence interval.

Gastric Swelling Factor

The gastric swelling factor is defined as the swelling factor for a hydrogel equilibrated with simulated gastric fluid at a pH of 2.0. As used herein, the term “simulated gastric fluid” refers to an aqueous solution of 0.0292% (w/w) CaCl₂ dihydrate, 0.22% (w/w) KCl, 0.5% (w/w) NaCl, and 0.15% (w/w) NaHCO₃. This solution has an unadjusted pH of 8.20 at 25° C. Simulated gastric fluid with a pH lower than 8.20 is made by titrating the solution with 1.04 molar HCl.

As defined herein, a pH responsive hydrogel is a hydrogel having a gastric swelling factor of at least 25%.

Intrinsic Viscosity

The intrinsic viscosity ([η]) of a macromolecule is a fundamental measure of the shape of the macromolecule in a given solvent (see, for example, C. Rha and P. Pradipasena, “Viscosity of Proteins”, in Functional Properties of Food Macromolecules, J. R. Mitchell and D. A. Ledward (Eds), 1986, Elsevier Applied Science Publishers Ltd, New York, Chapter 2). It is obtained from the limit of the specific viscosity divided by concentration when the concentration of protein approaches zero (see, for example, P. W. Atkins, Physical Chemistry, 6^{th} Edn, 1999, Oxford University Press, Oxford, Chapter 23.4), i.e.

$$[ η ] = {lim}_{c -> 0} \frac{{η}_{sp}}{c} = {lim}_{c -> 0} \frac{η - {η}_{0}}{c {η}_{0}} , \qquad ( 2 )$$

where 77 is the viscosity of a protein solution, ηₛₚ is the specific viscosity of the solution, c is the concentration of the protein in the solution and η₀ is the viscosity of the solvent.

Thus the intrinsic viscosity is readily determined from simple viscosity measurements. Suitable methods for the determination of [η] are given in R. H. Haschemeyer and A. E. V. Haschemeyer, Proteins, 1973, John Wiley & Sons Inc, New York, Chapter VII:5.

As referred to herein, the intrinsic viscosity of a globular protein at a given pH is the intrinsic viscosity of the globular protein at 25° C. in an aqueous solution of 0.1 molal sodium chloride of the given pH. Details of how to prepare suitable solutions are given in J. T. Yang and J. F. Foster, J. Am Chem Soc., 1954, 76, 1588-1595.

Unfolding Transition pH

As defined herein, the unfolding transition pH of a globular protein is the highest pH in the range pH 2 to pH 6 at which a decrease in pH of 0.5 pH units results in an increase in the intrinsic viscosity of the uncrosslinked protein of at least 50%. Thus the unfolding transition pH is the highest pH in the range pH 2 to pH 6 at which the following condition is satisfied:
([η]_{pH-0.5}/[η]_{pH})>1.5,
where [77]pH is the intrinsic viscosity of the uncrosslinked globular protein at the pH in question and [η]_{pH-0.5} is the intrinsic viscosity of the uncrosslinked globular protein at a pH of 0.5 pH units less than the pH in question.

### BRIEF DESCRIPTION OF THE INVENTION

We have surprisingly found that hydrogels comprising a cross-linked globular protein having an unfolding transition pH in the range pH 2 to 6 show enhanced swelling under gastric conditions even when compared with hydrogels comprising a fibrous protein, such as gelatin. Thus upon contact with gastric fluid, a hydrogel comprising a cross-linked globular protein having an unfolding transition pH in the range pH 2 to 6 dramatically increases the viscosity (or even solidifies) the contents of the stomach, thereby slowing gastric emptying and increasing the sensation of satiety.

Accordingly, in a first aspect, the present invention provides a food product comprising at least 50 grams of a pH responsive hydrogel comprising a cross-linked globular protein having an unfolding transition pH in the range pH 2 to 6.

In order to minimise the swelling of the hydrogel prior to ingestion it is preferable that the food product has a pH of greater than the unfolding transition pH. It is envisaged, however that the pH of the food product may be lower than the unfolding transition pH and that a barrier mechanism, such as encapsulation of the hydrogel, may be employed to limit pre-swelling.

In order for the effect of the hydrogel on gastric emptying to be significant, however, it is important that the amount of hydrogel incorporated within the food product be such that the swelled hydrogel occupies a substantial volume of the stomach. Therefore it is necessary that the food product comprises at least 50 g of the hydrogel and preferable that the food product comprises at least 70 g, more preferably at least 100 g. Preferably, also, the food product comprises less than 500 g of the hydrogel to minimise the impact of the hydrogel on the taste and texture of the food product and to avoid any discomfort due to excessive distension of the stomach.

In order to avoid the impact on taste and texture that may be caused by the incorporation of large amounts of hydrogel in the food product, whilst still retaining an enhanced satiety effect, it is preferable that the hydrogel has a gastric swelling factor of at least 50%, more preferably at least 100% and even more preferably at least 150%.

Without wishing to be bound by theory, it is believed that the enhanced swelling of the hydrogels of the present invention is owing to unfolding (denaturation) of the native compact tertiary structure of the globular protein. Thus, any edible globular protein may be used in the hydrogel of this invention provided that the globular protein has an unfolding transition pH in the range pH 2 to G. In order to maximise the volume change on unfolding, it is preferable that the globular protein has a very compact conformation at pH values above the unfolding transition pH but has a very extended conformation below the transition pH. In this respect it is preferable that the intrinsic viscosity of the globular protein at a pH in the range from the unfolding transition pH to pH 6 is less than 6 ml g⁻¹, more preferably in the range 2.5 to 5.0 ml g⁻¹. Also, it is preferable that the intrinsic viscosity of the globular protein at a pH in the range pH 2 to the unfolding transition pH is greater than 6 ml g⁻¹, more preferably greater than 7 ml g⁻¹ and even more preferably in the range 8 to 100 ml g⁻³.

A particularly suitable protein is a serum albumin, preferably bovine serum albumin (BSA). Intrinsic viscosities for BSA are reported in J. T. Yang and J. F. Foster, J. Am Chem Soc., 1954, 76, 1588-1595, from which data it is apparent that BSA has an intrinsic viscosity of around 3.5 ml g⁻¹ at pH 6 and an intrinsic viscosity of around 10 ml g⁻¹ at pH 2, with the unfolding transition pH being around pH 4.

To avoid the hydrogel unduly influencing the texture of the food product, it is preferable that the hydrogel is relatively soft. In this respect it is preferable that the hydrogel comprises at least 20% water by weight of the hydrogel, more preferably at least 40% and optimally from 50 to 90% water.

In order to obtain a hydrogel with sufficient strength to survive processing into a food product, it is preferable that the globular protein is present in an amount of at least 5% by weight of the pH responsive hydrogel, more preferably at least 7% and even more preferably at least 10%. On the other hand too high a protein content can impart too hard a texture to the hydrogel and so it is preferred that the that the globular protein is present in an amount of no more than 30% by weight of the pH responsive hydrogel, more preferably less than 25% and even more preferably less than 20%

The term “cross-linked” as used herein refers to the presence of chemical bonds between molecules (i.e. intermolecular bonds). The cross-links should be such that the hydrogel is swellable in simulated gastric fluid of pH 2 but are not labile such that the hydrogel will dissolve under such conditions. It will be appreciated, however, that in vivo the hydrogel will gradually be digested by the action of proteases present in the stomach and intestine.

To avoid too rapid a solubilisation of the hydrogel in the stomach, it is preferable that there are at least 2 moles of cross-links per mole of the globular protein, more preferably at least 3 and even more preferably at least 4. If the cross-linking density becomes too high, however, the swelling of the hydrogel becomes restricted. Therefore it is preferable that the cross-linking density is no higher than 50 moles of cross-links per mole of the globular protein, more preferably the cross-linking density is less than 25 moles of cross-links per mole of the globular protein and even more preferably less than 15 moles of cross-links per mole of the globular protein.

Any suitable functional group present on the protein may be used as a site for cross-linking. It is preferred, however that the cross-links are not between cysteine residues, i.e. preferably the cross-links do not comprise S—S bonds. This is because cysteine residues are almost exclusively buried within the internal structure of a globular protein (usually in order to provide intramolecular bonds) and so to utilise cysteine residues for cross-linking requires disruption of the compact native structure of the globular protein. On the other hand, a convenient functional group for forming cross-links between globular protein molecules is the amine group. For example, lysine residues which have a primary amine group are often found on the surface of the native conformation of globular proteins. Cross-linking of amine groups may be achieved by reaction with various chemicals such as diglycidyl ethers, epoxides and cyclodextrins. It is particularly preferred, however, that glutaraldehyde and/or genipin are used to cross-link the amine groups of the globular protein. In such a case the hydrogel will comprise cross-links comprising gluteraldehyde moeities and/or genipin moeties. Gluteraldehyde and genipin are particularly preferred owing to their relatively low cytotoxity. Genipin is a natural cross-linking agent from Gardenia Jasminoides Ellis. Details of the cross-linking mechanism of genipin can be found in M. F. Butler, Y. F. N G and P. D. A. Pudney, J. Polym. Sci.: Part A: Polyym. Chem., 2003, 41, 3941-3953.

In a preferred embodiment of the present invention, the hydrogel additionally comprises a cationic polysaccharide and preferably the cationic polysaccharide is cross-linked to the globular protein.

Cationic polysaccharides have previously been used to prepare hydrogels (see for example U.S. Pat. No. 5,037,664). Such hydrogels are swellable owing to the polyelectrolyte nature of the polysaccharide. Unfortunately, however, we have found that in the high ionic strength of the gastric environment, the charge on the polyelectrolyte is screened to such an extent that swelling is suppressed (and in some cases a negative gastric swelling factor results). Surprisingly, however, we have found that the presence of cationic polysaccharides in the protein hydrogels of the present invention greatly enhances the mechanical properties of the hydrogels without unduly restricting gastric swelling.

It is particularly preferred that the cationic polysaccharide is aminated as the amine groups then provide convenient functionalities for cross-linking the polysaccharde and for cross-linking the polysaccharide to the protein. A readily available food-grade cationic polysaccharide is chitosan.

In order to effectively enhance the mechanical properties of the hydrogel, it is preferable that the hydrogel comprises at least 0.05% cationic polysaccharide by weight of the hydrogel, more preferably at least 0.1% and even more preferably at least 0.5%. The cationic polysaccharide content should not be too high, however, otherwise the hydrogels become too stiff and are easily detected in the mouth. Therefore it is preferable that the hydrogel contains less than 7% cationic polysaccharide by weight of the hydrogel, more preferably less than 5% and even more preferably less than 3%.

In a preferred embodiment, the pH responsive hydrogel is present in the food product as a dispersion of gel particles and/or pieces. Such a product architecture allows for use of large amounts of the hydrogel whilst having a minimum impact on taste and texture of the food product. In order to minimise the impact of the hydrogel still further it is preferable that the particles are relatively small. In particular it is preferable that at least 90% by number of the gel particles have a size (i.e. maximum linear dimension) of less than 800 μm, preferably the size is less than 500 μm and even more preferably less than 300 μm.

The food product of the invention may be in any convenient form. Particularly preferred are liquid or spoonable forms as these are readily digestible and convenient. The food product may be a drink, a soup, a pasta or a cereal product. In a preferred embodiment the food product is a nutritional bar, i.e. a cohesive solid mass that supports its own weight and conveniently fits within the hand of a consumer.

The food product according to the invention is particularly suitable as a meal replacer for use in a weight loss or weight control plan. The terms “meal replacer” or “meal replacement products” as used herein refer to food products which are intended to replace one or more conventional meals a day as part of a weight loss or weight control plan; they are of a-controlled calorie content and are generally eaten as a single product or portion.

The calorie content of the food product is preferably controlled such that it is at least 50 Kcal, more preferably at least 90 Kcal, and even more preferably at least 100 Kcal. Preferably also the calorie content is less than 1500 Kcal, more preferably less than 700 Kcal, even more preferably less than 400 Kcal.

In order to provide balanced nutrition, it is also preferable that the food product comprises one or more of a carbohydrate and a fat. Suitable carbohydrates include sugars, starches and fibre. Carbohydrates may be included in any amount but are preferably in an amount from 0.1 to 60% by weight of the food product, more preferably 4 to 40%. Suitable fats may be vegetable or animal fats such as butter, olive oil, canola oil, sunflower oil and coconut oil. Fats may be included in any amount but are preferably limited to less than 30% by weight of the food product, more preferably less than 20% and even more preferably are present in an amount of from 0.1 to 5% by weight of the food product. Preferably 50% or less of the kilocalories of the product are provided from the fat.

The product also preferably contains a nutrient selected from a vitamin, a mineral and combinations thereof. Suitable vitamins include: vitamin A palmitate, thiamine mononitrate (vitamin B1), riboflavin (vitamin B2), niacinamide (vitamin B3), calcium D-pantothenate (vitamin B5), vitamin B6, vitamin B11, cyanocobalamin (vitamin B12), ascorbic acid (vitamin C), vitamin D, tocopheryl acetate (vitamin E), biotin (vitamin H), and vitamin K. Suitable minerals include: calcium, magnesium, potassium, zinc, iron, cobalt, nickel, copper, iodine, manganese, molybdenum, phosphorus, selenium and chromium. The vitamins and/or minerals may be added by the use of vitamin premixes, mineral premixes and mixtures thereof or alternatively they may be added individually.

The advantages of the present invention include greater efficacy of the satiety effect after consumption of a food product according to the invention; for example an enhanced feeling of satiety, feeling satiated sooner whilst eating and/or remaining satiated for a longer period of time after eating. These advantages are especially beneficial for the compliance with weight loss or weight control plans and/or the control or maintenance of body weight and/or body perception. There are also longer-term advantages associated with helping in the prevention of diseases related to being overweight.

Thus, the hydrogels and food products of this invention may be used in a method of enhancing the feeling of satiety in an individual and/or aiding adherence to a weight loss or weight control plan. The method comprises the step of the individual consuming a hydrogel or food product according to the invention.

A further aspect of the invention provides use of a pH responsive hydrogel comprising a cross-linked globular protein having an unfolding transition pH in the range pH 2 to 6, or of a food product according to the invention, to provide an enhanced feeling of satiety to a person consuming the hydrogel and/or to aid adherence to a weight loss or weight control plan.

The pH responsive hydrogel comprising a cross-linked globular protein having an unfolding transition pH in the range pH 2 to 6, or a food product according to the invention, may also be used for the manufacture of a medicament to provide an enhanced feeling of satiety to a person consuming the hydrogel and/or to aid adherence to a weight loss or weight control plan.

A feeling of satiety as referred to herein means a greater or enhanced feeling of satiety (satiation) after eating and/or a longer lasting feeling of satiety after eating. Such effects typically reduce feelings of hunger and/or extend the time between food intake by an individual and can result in a smaller amount of food and/or fewer calories consumed in a single or subsequent sitting. The references herein to satiety include both what is strictly referred to as satiation and satiety, including end of meal satiety and between meals satiety. Satiety may also be perceived by an individual as a feeling of ‘fullness’, reduced hunger and/or reduced appetite.

In a further aspect of the invention, there is provided a process of manufacturing a food product comprising the steps of:
(a) selecting a globular protein having an unfolding transition pH in the range pH 2 to 6; then
(b) cross-linking the globular protein at a pH greater than the unfolding transition pH, thereby to form a pH responsive hydrogel; and then
(c) combining the hydrogel with an edible matrix thereby to form the food product.

Step (c) is performed after step (b) as this allows the properties of the hydrogel to be manipulated independently of the edible matrix.

The inventive process produces products which show enhanced efficacy for increasing the feeling of satiety in an individual. Therefore there is also provided products obtainable by the process.

The process is particularly suited for the manufacture of the inventive food products described hereinabove.

The edible matrix may be any foodstuff or food ingredient or combination thereof. In particular the matrix be an edible liquid, solid or gel. If the matrix is an aqueous composition (i.e. contains greater than 20% water by weight of the matrix) it is preferable the matrix has a pH greater than the unfolding transition pH of the globular protein in order to avoid any pre-swelling of the hydrogel. Alternatively the matrix may be substantially non-aqueous, e.g. comprise less than 20% water, preferably less than 10% water by weight of the matrix. The matrix may be in the form of an oil-in-water or a water-in-oil emulsion.

Preferably the hydrogel and edible matrix are combined in step (c) in a ratio of from 1:100 to 100:1 by weight, more preferably in a ratio of from 1:10 to 10:1, even more preferably in a ratio of from 2:1 to 1:2.

### DETAILED DESCRIPTION OF THE INVENTION

The present invention will be further illustrated with reference to the following non-limiting examples.

### Example 1

This example demonstrates that hydrogels comprising a cross-linked globular protein having an unfolding transition pH in the range pH 2 to 6 show enhanced swelling under gastric conditions.

Materials

The following proteins were used:
Bovine Serum Albumin [BSA] (Three different types were used—A3912 and A6918 types, Initial fractionation by Heat Shock, and 4503 type, Initial fractionation by cold alcohol precipitation, all supplied by Sigma)
Gelatin (Type A from porcine skin, supplied by Sigma)
Soy protein isolate [SPI] (Supro 65/1, supplied by Protein Technology International)

The cross-linking agent was Genipin (supplied by Challenge biopolymeres Co, Ltd).

Salts used to prepare the simulated gastric fluid were CaCl₂ dihydrate (Sigma), KCl (BDH laboratory supplies), NaCl (Sigma) and NaHCO₃ (Sigma).

Preparation of Stock Solutions

Stock solutions were prepared as follows.

BSA Stock Solutions—

4 g of BSA was added to 16 g water at 25° C. and gently stirred for 2 hours at 25° C.

Gelatin Stock Solution—

4 g of gelatin was added to 16 g water at 60° C. and gently stirred for 2 hours at 60° C.

SPI Stock Solution—

8 g of SPI was added to 32 g of water at 25° C. and dispersed at 25° C. using a Whirlimixer™ (from Fisons Scientific Apparatus Ltd)

Genipin Stock Solution—

0.565 g genipin was added to 24.435 g water at 25° C. and gently stirred for 2 hours at 25° C.

Preparation of Hydrogels

The hydrogels were prepared by mixing 15 g of the protein stock solution with 5 g of the genipin stock solution to give gels comprising 15 wt % protein and 0.565 wt % genipin (25 art). For the BSA and SPI gels the mixing was done at 25° C. For the gelatin gel, the stock solution and the genipin solution were equilibrated in a water bath at 35° C. prior to mixing in order to avoid thermal gelation of the gelatin. Following mixing, each of the samples was incubated in a sealed container in a water bath at 35° C. for 24 hours to induce gelation.

Swelling Test

Simulated gastric fluid was prepared as follows. 7.5 g of NaHCO₃ was dissolved in ˜500 ml of water in a 5 l volumetric flask. 1.46 g of CaCl₂ dihydrate, 11 g of KCl, and 25 g NaCl were then added to the flask, followed by de-ionised water to the 5 l mark.

The simulated gastric fluid was then divided into several flasks, and concentrated hydrochloric acid (1.04N) used to titrate the flasks to produce fluids having a pH ranging from pH 0.9 to pH 7.

The swelling factor for each hydrogel in each fluid was then determined as described in the “Tests and Definitions” section hereinabove.

Results

The variation of the swelling factor for the hydrogels as a function of the pH of the simulated gastric fluid is set out in table 1.

TABLE 1

| | Swelling Factor (%) for hydrogel of | | | | |
|---|---|---|---|---|---|
| pH | BSA (A3912) | BSA (A6918) | BSA (4503) | SPI | Gelatin |
| 0.9 | 65.0 ± 9.4 | 80.9 ± 2.0 | 66.1 ± 2.9 | −4.8 ± 2.6 | 53.9 ± 6.0 |
| 1.7 | 134 ± 11 | 134 ± 11 | 145 ± 26 | 10.9 ± 8.7 | 86.7 ± 7.1 |
| 2.3 | 115 ± 14 | 126 ± 11 | 113.4 ± 4.2 | −6.2 ± 7.0 | 71.6 ± 2.4 |
| 2.5 | 140 ± 11 | 139 ± 22 | 132 ± 16 | −6.1 ± 5.1 | 79.5 ± 6.9 |
| 2.7 | 99.1 ± 5.6 | 96.9 ± 9.4 | 80.6 ± 2.6 | −27.2 ± 1.8 | 62.3 ± 2.5 |
| 3.1 | 77 ± 16 | 29.6 ± 7.2 | 34 ± 14 | −25.9 ± 4.0 | 65.7 ± 5.1 |
| 3.6 | 32 ± 11 | 20 ± 12 | 37.3 ± 8.7 | −19.6 ± 4.4 | 71.5 ± 1.8 |
| 3.9 | 21 ± 10 | 6.1 ± 8.3 | 8 ± 14 | −9.5 ± 2.3 | 73.4 ± 8.3 |
| 4.3 | 29 ± 11 | 22 ± 21 | 17 ± 21 | 0.8 ± 4.9 | 60.2 ± 5.6 |
| 4.4 | −9.4 ± 4.1 | −0.3 ± 3.6 | −11.9 ± 1.0 | −10.8 ± 3.3 | 27.1 ± 2.2 |
| 5.2 | 1.5 ± 2.7 | 0.0 ± 3.4 | −4.1 ± 0.7 | −31.6 ± 2.9 | 21.5 ± 3.0 |
| 6.5 | 23.7 ± 2.8 | 21.7 ± 5.2 | 14.9 ± 2.6 | −4 ± 11 | 32.7 ± 4.8 |

The data in table 1 clearly illustrates that hydrogels made from a globular protein having a transition pH in the range pH 2 to pH 6 (i.e. BSA hydrogels) show massive swelling at gastric pH (i.e. pH of ˜2). In contrast, hydrogels made from SPI show no significant swelling at any of the pHs studied at gastric ionic strength. Hydrogels made from the fibrous protein gelatin do show significant swelling at all of the pHs studied but this swelling is only moderately dependent upon pH and is less pronounced at gastric pH than the swelling observed for the BSA hydrogels.

### Example 2

This example demonstrates a hydrogel comprising a cross-linked globular protein having an unfolding transition pH in the range pH 2 to 6 suitable for use in the present invention.

A hydrogel of BSA (A3912) was prepared and tested as in Example 1 except that a more dilute genipin stock solution was used such that the final gel of comprised 15 wt % protein and 0.226 wt % genipin (10 mM). The results of the swelling test are given in table 2.

TABLE 2

| pH | Swelling factor (%) |
|---|---|
| 1.0 | 206 |
| 1.8 | 335 |
| 2.2 | 201 |
| 2.5 | 251 |
| 2.6 | 213 |
| 3.3 | 158 |
| 3.5 | 144 |
| 3.7 | 72 |
| 4.3 | 21 |
| 4.9 | −31 |
| 7.5 | 81 |

A comparison of the data in tables 1 and 2 illustrates that, for a 15% BSA hydrogel, a reduction in the cross-linking density (i.e. by using a lower concentration of the cross-linking agent genipin) results in almost a three-fold increase in the gastric swelling factor of the hydrogel whilst having little influence on the swelling factor at pHs above the unfolding transition pH.

### Example 3

This example demonstrates a composite hydrogel suitable for use in the present invention. The hydrogel comprises a cross-linked globular protein having an unfolding transition pH in the range pH 2 to 6 (BSA) and a cationic polysaccharide (chitosan).

Preparation of Hydrogels

Two hydrogels (A and B) according to the invention along with a comparative hydrogel (C) were prepared as follows (all mixing was done at 20° C. and the gels were cured for 4 days at 20° C. in sealed 20 ml vials prior to testing):

Hydrogel A—

Stock solutions of 20 wt % BSA in de-ionised water and 2.26 wt % genipin in de-ionised water were combined to give a hydrogel consisting of 15 wt % BSA and 0.565 wt % genipin in de-ionised water.

Hydrogel B—

Stock solutions of 30 wt % BSA in de-ionised water, 3.75% chitosan (90% deacetylated from Primex) in 1% aqueous acetic acid and 5.65 wt % genipin in 1% aqueous acetic acid were combined to give a hydrogel consisting of 15 wt % BSA, 1.5 wt % chitosan, 0.565 wt % genipin and 0.5% acetic acid in de-ionised water.

Hydrogel C—

Stock solutions of 2 wt % chitosan in 1% acetic acid and 2.26 wt % genipin in 1% acetic acid were combined to give a hydrogel consisting of 1.5 wt % chitosan, 0.565 wt % genipin and 1% acetic acid in de-ionised water.

Testing

Small cylindrical specimens (4 mm diameter×4 mm height) were cut from each hydrogel, accurately weighed, and placed in a large excess of simulated gastric fluid having a pH of 1.8 or 4.8 (prepared as described in Example 1). Following incubation in the fluid for 24 hours at 20° C. each specimen was removed from the fluid and weighed to calculate the gastric swelling factor.

Immediately following weighing, each specimen was subjected to mechanical testing. The mechanical testing was performed on a Stable Micro System TA.XTplus™ Texture Analyser, employing a 5 kg load cell and operating in compression mode using a flat Plexiglas plate. The data from the texture analyser was used to calculate the elastic modulus of the gels.

Results

The results of the swelling and mechanical tests are given in Table 3.

TABLE 3

| | Simulated Gastric Fluid | | Simulated Gastric Fluid | |
|---|---|---|---|---|
| | pH 1.8 | | pH 4.8 | |
| | Swelling | Modulus | Swelling | Modulus |
| Hydrogel | Factor (%) | (kPa) | Factor (%) | (kPa) |
| A (BSA) | 99 ± 23 | 1.4 ± 0.3 | −25 ± 5 | 20 ± 2 |
| B (BSA + Chitosan) | 56 ± 12 | 25 ± 6 | −5 ± 7 | 36 ± 9 |
| C (Chitosan) | −56 ± 4 | 35 ± 4 | −68 ± 13 | 99 ± 1 |

These results demonstrate the enhanced gastric swelling of hydrogels according to the invention (A and B) compared with a chitosan hydrogel (C). The results also demonstrate that a composite hydrogel (B) has enhanced stiffness compared with an equivalent BSA hydrogel (A).

### Example 4

This example demonstrates a food product according to the invention and its manufacture.

Preparation of Hydrogel

Small particles of hydrogel with diameters of less than 700 μm are prepared using an emulsion method. 30 g of BSA is dissolved in 150 ml of water in a 1 litre jacketed vessel. 500 ml of sunflower oil is then added and the resulting mixture stirred with an overhead stirrer operating at 1000 rpm for 30 minutes to generate a water-in-oil emulsion. 50 ml of a solution of 100 mM genipin in water is then added and the whole mixture stirred at 1000 rpm for about 100 hours while the reaction proceeds. All stirring is performed at a constant temperature of around 15° C. achieved through circulation of cold water through the jacket of the vessel. At the end of the reaction time the mixture is centrifuged at 3000 g for 6 minutes and the oil phase removed. The resulting hydrogel particles are then washed and the centrifugation step repeated in order to remove all traces of the oil. Around 200 g of hydrogel particles are then recovered consisting of approximately 13% w/w BSA, 0.5% w/w genipin moieties and 86.5% w/w water.

Preparation of Edible Matrix

An edible matrix is prepared according to the formulation given in table 4.

TABLE 4

| Ingredient | % by weight |
|---|---|
| Skimmed Milk Powder (SMP) | 5.33 |
| Sucrose | 5.78 |
| Flavour (French Vanilla) | 0.80 |
| Canola Oil | 0.44 |
| Lecithin | 0.13 |
| Emulsifier | 0.13 |
| Stabiliser | 0.27 |
| Water | 87.12 |
| | TOTAL 100.00 |

The matrix is prepared as follows. The water is heated to 50° C. and pre-blended SMP, stabiliser and sucrose added. The resulting mixture is then heated to 55° C. and mixed at high shear with an Ultra-Turrax™ mixer for 15 minutes. The pre-heated fat phase (70° C.) consisting of the oil, lecithin and emulsifier is then added and mixing continued for 2 minutes. The flavour is then added. The whole matrix is then homogenised in two stages: 100/40 bar (Niro™ homogeniser with a throughput of 14 kg/hr and a back-pressure of 4 bar) and then sterilised using a small UHT line (heating/holding section at 145° C., cooling section at 72° C.). 450 g of the matrix is then filled into a 2 litre container.

Combination of Hydrogel with Edible Matrix

The 200 g of hydrogel particles are added to the 450 g of edible matrix in the 2 l container and the mixture gently stirred until the hydrogel particles are evenly dispersed. 325 g of the resulting dispersion is then filled into a 330 ml bottle.

The approximate composition of the resulting food product is given in table 5.

TABLE 5

| Ingredient | % by weight | Mass (g) |
|---|---|---|
| SMP | 3.69 | 12.0 |
| Sucrose | 4.00 | 13.0 |
| Flavour | 0.55 | 1.8 |
| Canola oil | 0.31 | 1.0 |
| Lecithin | 0.09 | 0.3 |
| Emulsifier | 0.09 | 0.3 |
| Stabiliser | 0.18 | 0.6 |
| BSA | 4.00 | 13.0 |
| Genipin | 0.15 | 0.5 |
| Water | 86.94 | 282.5 |
| | TOTAL 100.00 | TOTAL 325.0 |

The food product has a total protein content of approximately 5% w/w, a total carbohydrate content of approximately 6%, a total fat content of approximately 1% and a total calorific content of approximately 165 Kcal. In use, an individual would consume the whole of the food product in place of consuming a conventional meal.

1. A food product comprising at least 50 grams of a pH responsive hydrogel comprising a cross-linked protein; characterized in that the protein is a globular protein having an unfolding transition pH in the range pH 2 to 6.

2. A food product according to claim 1 wherein the hydrogel has a gastric swelling factor of at least 50%.

3. A food product according to claim 1 wherein the food product has a pH of greater than the unfolding transition pH.

4. A food product according to claim 1 wherein the globular protein is a serum albumin.

5. A food product according to claim 1 wherein the globular protein is present in an amount of from 5 to 30% by weight of the pH responsive hydrogel.

6. A food product according to claim 1 wherein globular protein is cross-linked by covalent cross-links between primary amine groups on the glovular protein.

7. A food product according to claim 6 wherein the covalent cross-links comprise one or moieties selected from a glutaraldehyde moiety and a genipin moiety.

8. A food product according to claim 1 wherein the pH responsive hydrogel additionally comprises a cationic polysaccharide.

9. A food product according to claim 8 wherein the cationic polysaccharide is chitosan.

10. A food product according to claim 1 wherein the pH responsive hydrogel is present as a dispersion of gel particles.

11. A food product according to claim 10 wherein at least 90% by number of the gel particles have a size of less than 800 μm.

12. A food product according to claim 1 wherein the food product is in a liquid or spoonable form.

13. A food product according to claim 1 wherein the food product is a drink, a soup, a pasta or a cereal product.

14. A food product according to claim 1 wherein the food product is a nutritional bar.

15. A food product according to claim 1 wherein the food product is a meal replacer for use in a weight loss or weight control plan.

16. A method of enhancing the feeling of satiety in an individual and/or aiding adherence to a weight loss or weight control plan, the method comprising the step of administering to the individual a composition comprising a pH responsive hydrogel comprising a cross-linked globular protein having an unfolding transition pH in the range pH 2 to 6.

17. A method according to claim 16 wherein the composition comprising a pH responsive hydrogel comprising a cross-linked globular protein having an unfolding transition pH in the range pH 2 to 6, is a food product according to claim 1.

18. (canceled)

19. A process of manufacturing a food product comprising the steps of:
(a) selecting a globular protein having an unfolding transition pH in the range pH 2 to 6; then
(b) cross-linking the globular protein, at a pH greater than the unfolding transition pH, thereby to form a pH responsive hydrogel; and then
(c) combining the hydrogel with an edible matrix thereby to form the food product.

20. A process according to claim 19 wherein the edible matrix is aqueous and has a pH greater than the unfolding transition pH of the globular protein.

21. A process according to claim 19 wherein the edible matrix is substantially non-aqueous.

22. A process according to claim 20 wherein the hydrogel and edible matrix are combined in step (c) in a ratio of from 1:100 to 100:1 by weight.
